(19) United States
(12) Patent Application Publication
(10) Pub. No.: US 2024/0336287 A1
(43) Pub. Date: Oct. 10, 2024

(54) SEALING RING WITH LOCKING AGAINST TRANSLATIONAL MOVEMENT

(71) Applicant: TALLANO TECHNOLOGIES, BOULOGNE BILLANCOURT (FR)

(72) Inventors: Loïc ADAMCZAK, BOULOGNE BILLANCOURT (FR); Adrien MAISTRE, BOULOGNE BILLANCOURT (FR); Pascal BONNAUD, BOULOGNE BILLANCOURT (FR)

(21) Appl. No.: 18/578,147

(22) PCT Filed: Jun. 28, 2022
(86) PCT No.: PCT/EP2022/067685

§ 371 Date: Jan. 10, 2024

(30) Foreign Application Priority Data
Jul. 16, 2021 (FR) FR2107699

(51) Int. Cl. B61H 5/00; F16D 65/095

(52) U.S. Cl. CPC B61H 5/00; F16D 65/095

(57) ABSTRACT

This relates to a friction assembly including: a brake head including a secondary channel, a friction plate including a primary channel and adapted to be fixed to the brake head, and a connecting ring arranged in the secondary channel and establishing a connection with the primary channel when the primary channel is aligned with the secondary channel; the friction assembly further including a manifold block having a cavity connected to a suction device, and forming an integral part of the brake head. The block has a hole connecting the cavity to the secondary channel, and the friction assembly includes a securing mechanism for securing the ring to the block when the ring is arranged in the hole and in the secondary channel.

### CROSS-REFERENCE TO RELATED APPLICATIONS

This application is the US national stage of PCT/EP2022/067685, filed Jun. 28, 2022 and designating the United States, which claims the priority of FR2107699, filed Jul. 16, 2021. The entire contents of each foregoing application are incorporated herein by reference.

### BACKGROUND OF THE INVENTION

### Field of the Invention

This invention relates to the braking of railway rolling stock and in particular to the friction assemblies of braking systems for railway rolling stock. Rolling stock is understood to mean all vehicles configured to run on rails, such as trains, trams, and subway cars.

### Description of the Related Art

The braking system generally comprises a disc secured to a wheel or axle of the railway rolling stock. The braking system further comprises a friction assembly comprising a brake head that supports a friction plate. The friction plate usually comprises means of attachment to the brake head and a friction pad. When a driver activates the braking system, the friction pad of the friction plate comes into contact with the disc to exert a braking force on the disc. Thus, by friction, the friction plate slows down the disc secured to the wheel or axle. Railway rolling stock generally has two friction assemblies, arranged one on either side of the disc so as to grip, or in other words sandwich, the disc so as to compress it on both sides. The friction pad of the friction plate usually comprises a metal material such as cast iron, a sintered material, or a composite material. Thus, when the friction pad of the friction plate rubs against the disc, particles of material from the friction pad and the disc are released into the ambient atmosphere around the friction assembly. The braking system thus emits atmospheric pollution in the form of particles of varying granularity.

Effort has therefore been made to capture the particles emitted during braking, in particular by placing a suction device, powered by a pump, near an area of emission of particles coming from the friction pad of the friction plate. In addition, effort has been made to ensure that this particle suction is as effective as possible.

One solution to this problem is the friction assembly illustrated in FIGS. 17 and 18, which represents the prior art. This prior art is described in document FR 3 088 394. FIG. 17 is a bottom view of this assembly, and FIG. 18 is a cross-section along line XVIII-XVIII of FIG. 17.

Brake head 103 extends longitudinally in a longitudinal direction X, and transversely in a transverse direction Y. Plane X-Y is horizontal. The Z direction, perpendicular to plane X-Y so as to form a frame of reference (X,Y,Z), is vertical and oriented upwards. Brake head 103 comprises a lower face 131 intended to accommodate a friction plate 102, and an upper face 132, each extending parallel to plane X-Y.

Brake head 103 has, on lower face 131, a concave dovetail receiving slide 105, which extends longitudinally from a first end of brake head 103 to the vicinity of the second end of brake head 103 where this slide has no opening. Brake head 103 comprises, on longitudinal axis X, two secondary channels 138 spaced apart from each other. Each secondary channel 138 connects upper face 132 to the bottom of slide 105 on the upper face.

Friction plate 102 is in two identical parts, each part having a friction face 121 intended to be in frictional contact with the disc (not shown) of the vehicle and an opposite face 122. Opposite face 122 has a convex dovetail section 104 configured to engage with receiving slide 105. During use, a first portion of plate 102 is pushed in along longitudinal axis X by sliding dovetail section 104 in slide 105, until the end of slide 105 is reached. Then, the second portion of plate 102 is pushed in along longitudinal axis X by sliding dovetail section 104 in slide 105, until pressed against the first portion of plate 102, the contacting surfaces of the first portion and the second portion ideally being shaped to fit together along their entire surface.

Each of the portions of plate 102 comprises a primary channel 128 oriented along vertical axis Z. When these portions are fixed on brake head 103 during use, each of the two primary channels 128 is positioned in line with a secondary channel 138. Axis B denotes the main axis of a primary channel 128 and the secondary channel 138 located facing it, primary channel 128 and secondary channel 138 therefore being coaxial. Thus, each primary channel 128 forms, with one of the secondary channels 138 provided in brake head 103, a circuit which makes it possible to suction particles emitted by friction plate 102 during braking. Axis B is therefore parallel to vertical axis Z.

A connecting ring 108, consisting of a tube and a flange 1082 which extends this tube radially outwards at one of its ends, is mounted in secondary channel 138. The tube is inserted into secondary channel 138, the outside diameter of the tube being equal to the inside diameter of secondary channel 138 so as to ensure the best possible sealing. Flange 1082 is housed in an annular housing of brake head 103, this housing being centered on main axis B and facing opposite face 122 of plate 102. The annular housing has a diameter greater than that of secondary channel 138 and less than that of flange 1082. Thus, flange 1082 is sandwiched between the dovetail section of plate 102 and the bottom of slide 105 of brake head 103. Once in its housing, flange 1082 is in contact with face 122 of dovetail section 104 of plate 102. This contact is achieved for example by deformation (crushing) of flange 1082 between the bottom of the housing and face 122. Alternatively (as shown in FIG. 18), this contact is made by compression of a helical spring mounted on the tube between flange 1082 and the bottom of the housing. Thus, flange 1082 itself, or the helical spring, is a return mechanism 190 which allows pressing flange 1082 against dovetail section 104 (see below).

Connecting ring 108 completely traverses brake head 103 and protrudes beyond its upper face 132, to its lower face 131 which is provided with slide 105. Fixed on this end of the tube of ring 108 is a pipe 150 that is connected to a suction device (not shown) and which allows suctioning, through primary channel 128 and secondary channel 138, the particles which come from the braking of the railway vehicle due to wear of plate 102. Pipe 150 and the suction device constitute a particle removal device.

Connecting ring 108 serves to guide the particles which come from braking, from primary channel 128 of plate 102 to secondary channel 138 of brake head 103. Connecting ring 108 therefore aims to prevent possible leaks through primary channel 128 and secondary channel 138. In particular, connecting ring 108 aims to reduce the amount of particles resulting from braking which could slip into the gap at the interface between friction plate 102 and brake head 103, and above all to prevent a flow of air from the outside from entering through this gap into secondary channel 138, which would degrade the suction by the suction device.

In addition, connecting ring 108 is pressed against dovetail section 104 by means of a return mechanism 190, as indicated above. Return mechanism 190 effectively prevents the passage of air at the interface between plate 102 and brake head 103 at primary channel 128 and secondary channel 138, this passage of air being due to clearances at the interface between brake head 103 and plate 102.

Ring 108 must be prevented from translational movement in both directions along axis B, so as to be integral with brake head 103. This is achieved in one direction by flange 1082 at the lower end of ring 108. This is achieved in the other direction by fixing the upper end of ring 108 on the pipe 150 which is connected to the suction device. Ring 108 is in two parts. After fixing the upper part of ring 108 on pipe 150, and inserting the lower part of ring 108 into secondary channel 138, the upper part and the lower part of the ring are made integral, for example by screwing, welding, or any other appropriate means.

However, this bidirectional prevention of translational movement implies having access to both ends of ring 108. In certain configurations, the suction device, which is for example a pneumatic manifold block, is an integral part of brake head 103.

Thus, we have a friction assembly for a braking system for railway rolling stock, the friction assembly comprising on the one hand a brake head comprising a lower face and an upper face, and on the other hand at least one plate made of friction material comprising a first face which is the friction face, and a second face which is adapted to be fixed on the lower face by a fixing mechanism, the plate comprising at least one primary channel which connects the first face and the second face, the brake head comprising at least one secondary channel having a central axis B, the at least one primary channel being adapted to be aligned with one of the at least one secondary channel(s), and at least one connecting ring arranged in the secondary channel and establishing a connection with the primary channel, the friction assembly further comprising a manifold block connected to a suction device, this block forming an integral part of the brake head at the upper face.

In this configuration, one end of ring 108 (upper end, towards the suction device side) is not accessible. The assembly of ring 108 on brake head 103 is then not possible.

### DESCRIPTION OF THE INVENTION

The present invention aims to remedy these disadvantages.

The invention aims to propose a friction assembly for a railway braking system in which the manifold block which is connected to a suction system, for example a pneumatic manifold block, is an integral part of the brake head, which allows mounting on the brake head a connecting ring which allows particles emitted by plate wear to be expelled towards the suction device.

This goal is achieved due to the fact that the block has a cavity and at least one hole which connects the cavity and the upper face and which is aligned with the at least one secondary channel and in which the connecting ring is able to slide, the cavity being connected by a circuit to the suction device; and the fact that it comprises a securing mechanism for securing the at least one connecting ring to the block when the at least one connecting ring is arranged in the at least one hole and in the at least one secondary channel.

By means of these arrangements, each connecting ring is adapted to be inserted into the hole and into the secondary channel so as to place the plate in communication with the suction device. The connecting ring is then secured to the block by the securing mechanism. The ring is thus kept secured to the brake head so that, during operation, the discharge of particles from the plate towards the suction device is reliably achieved.

For example, the at least one connecting ring comprises a body and a flange at a first end of the body, the distal end of the body carrying tabs which extend radially outwards in the cavity, and the securing mechanism comprises the flange, the tabs, and the internal edge of the at least one hole of the cavity.

The securing of the connecting ring(s) to the block is thus achieved by a simple snap-fit.

For example, the at least one connecting ring comprises a body and a flange at a first end of the body, the distal end of the body carrying tabs which are plastically deformed radially outwards in the cavity, and the securing mechanism comprises the flange, the tabs, and the internal edge of the at least one hole of the cavity. Separating the connecting ring(s) from the block by plastic deformation of the tabs is thus less easy.

For example, the at least one connecting ring comprises a body and a flange at a first end of the body, the distal end of the body carrying at least one protuberance which extends radially outwards in the cavity, the at least one hole carrying at least one groove within which the at least one protuberance is adapted to slide, the internal edge of the at least one hole of the cavity comprising a housing adapted to receive the protuberance, and the securing mechanism comprises the flange, the protuberance, and the housing.

Thus, the securing of the connecting ring(s) to the block is carried out by a bayonet movement of the ring, and is removable by performing the opposite movement.

For example, the friction assembly further comprises a return mechanism which is adapted to press the ring against the second face.

Thus, the seal between the connecting rings and the plate, on the discharge path of the particles released by the plate, is improved.

For example, the fixing mechanism comprises a receiving slide which is formed on the lower face, and a dovetail section which is formed on the second face and which is configured to engage with the receiving slide.

The fixing of the plate to the brake head is thus facilitated since it is achieved by sliding, and furthermore is removable.

The invention also relates to a method for securing a connecting ring mounted on a brake head to a manifold block connected to a suction device, the brake head comprising a lower face, an upper face, and at least one secondary channel (38) of central axis A, the block forming an integral part of the brake head at the upper face, the brake head and the connecting ring forming part of a friction assembly for a braking system for railway rolling stock, the friction assembly further comprising a plate made of friction material comprising a first face which is the friction face, a second face which is adapted to be fixed to the lower face by a fixing mechanism, and at least one primary channel which connects the first face and the second face, the at least one connecting ring being arranged in the at least one secondary channel and establishing a connection with the at least one primary channel when the at least one primary channel is aligned with one of the at least one secondary channel(s).

According to the invention, the method comprises the following steps:
(a) The block is provided with a cavity which is connected by a circuit to the suction device, and with at least one hole which connects the cavity and the upper face and which is aligned with the at least one secondary channel and in which the at least one connecting ring is adapted to slide;
(b) The at least one connecting ring is arranged in the at least one hole and in the at least one secondary channel by sliding it along axis A from the lower face;
(c) The at least one connecting ring is secured to the block by means of a securing mechanism;
(d) Assembly of the plate onto the brake head is carried out until the plate covers the at least one connecting ring.

For example, the at least one connecting ring comprises a body and a flange at a first end of the body, the distal end of the body carrying tabs which extend radially outwards in their rest positions, such that, in step (b), the tabs approach each other elastically when the body slides in said at least one hole and in said at least one secondary channel, and such that, in step (c), the tabs return to their rest positions and are able to bear against the internal edge of the at least one hole of the cavity, the securing mechanism comprising the flange, the tabs, and the internal edge of the at least one hole.

For example, the at least one connecting ring comprises a body and a flange at a first end of the body, the distal end of the body carrying tabs which extend substantially as an extension of the body in their rest positions, such that, in step (b), the body slides freely in the at least one hole and in the at least one secondary channel, and such that, in step (c), the tabs are crushed against the bottom of the cavity such that the tabs are plastically deformed radially outwards and are able to bear against the edge of the at least one hole of the cavity, the securing mechanism comprising the flange, the tabs, and the internal edge of the at least one hole.

For example, the at least one connecting ring comprises a body and a flange at a first end of the body, the distal end of the body carrying at least one protuberance which extends radially outwards, and the at least one hole carrying at least one groove in which the at least one protuberance is adapted to slide, and the internal edge of the at least one hole of the cavity comprising a housing adapted to receive the at least one protuberance such that, in step (b), the body slides freely in the at least one hole and in the at least one secondary channel until the distal end of the body emerges into the cavity, and such that, in step (c), the ring is pivoted about main axis A until one of said at least one protuberance(s) is located facing the housing, then the ring is slid in the opposite direction until one of the at least one protuberance(s) is housed in the housing and bears against the bottom of the housing, the securing mechanism comprising the flange, the protuberance, and the housing.

### BRIEF DESCRIPTION OF THE DRAWINGS

The invention will be well understood and its advantages will be more apparent from reading the following detailed description of some embodiments represented by way of non-limiting examples. The description refers to the attached drawings, in which:

FIG. 1 is a perspective longitudinal section view in plane (X, Z) of a friction assembly according to a first embodiment of the invention, with the plate assembled to the brake head;

FIG. 2 is a section view in plane (X, Z) of the region of the friction assembly which comprises the manifold block, according to a first embodiment of the invention, before the rings are secured to the block.

FIG. 3 is a section view in plane (X, Z) of the region of the friction assembly which comprises the manifold block, according to a first embodiment of the invention, at a later step than the step in FIG. 2.

FIG. 4 is a section view in plane (X, Z) of the region of the friction assembly which comprises the manifold block, according to a first embodiment of the invention, at a later step than the step in FIG. 3.

FIG. 5 is a section view in plane (X, Z) of the region of the friction assembly which comprises the manifold block, according to a first embodiment of the invention, after the rings are secured to the block.

FIG. 6 is a section view in plane (X, Z) of a portion of the friction assembly 1 illustrated in FIG. 1.

FIG. 7 is a section view in plane (X, Z) of the region of the friction assembly which comprises the manifold block, according to a first embodiment of the invention, which shows the separation of the rings from the block.

FIG. 8 is a section view in plane (X, Z) of the region of the friction assembly which comprises the manifold block, according to a second embodiment of the invention, before the rings are secured to the block.

FIG. 9 is a section view in plane (X, Z) of the region of the friction assembly which comprises the manifold block, according to a second embodiment of the invention, at a later step than the step in FIG. 8.

FIG. 10 is a section view in plane (X, Z) of the region of the friction assembly which comprises the manifold block, according to a second embodiment of the invention, at a later step than the step in FIG. 9.

FIG. 11 is a section view in plane (X, Z) of the region of the friction assembly which comprises the manifold block, according to a second embodiment of the invention, after the rings are secured to the block.

FIG. 12 is a section view in plane (X, Z) of the region of the friction assembly which comprises the manifold block, according to a second embodiment of the invention, which shows the separation of the rings from the block.

FIG. 13 is a perspective partial section view in plane (X, Z) of the region of the friction assembly which comprises the manifold block, according to a third embodiment of the invention, before the rings are secured to the block.

FIG. 14 is a perspective partial section view in plane (X, Z) of the region of the friction assembly which comprises the manifold block, according to a third embodiment of the invention, at a later step than the step of FIG. 13.

FIG. 15 is a perspective partial section view in plane (X, Z) of the region of the friction assembly which comprises the manifold block, according to a third embodiment of the invention, at a later step than the step of FIG. 14.

FIG. 16 is a perspective partial section view in plane (X, Z) of the region of the friction assembly which comprises the manifold block, according to a third embodiment of the invention, after the rings are secured to the block.

FIG. 17, already described, is a bottom view of a friction assembly according to the prior art.

FIG. 18, already described, is a cross-section along line XVIII-XVIII of FIG. 17.

### DETAILED DESCRIPTION OF THE INVENTION

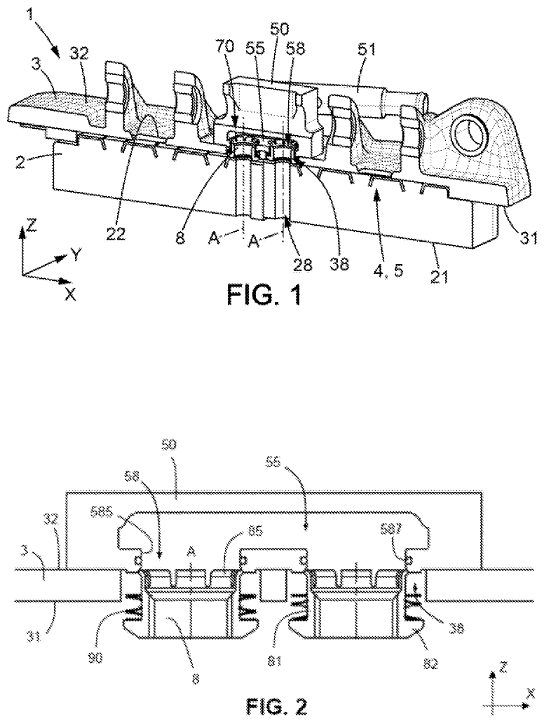

FIG. 1 illustrates a friction assembly 1 for a braking system for railway rolling stock. For example, these brakes are disc brakes. For example, these brakes are brakes on a running surface of the rolling stock wheel. The assembly extends longitudinally along a longitudinal axis X, and vertically along a vertical axis Z. The transverse axis Y forms a trigonometric frame of reference with axes X and Z. Friction assembly 1 is shown in a perspective view. For clarity, the assembly is represented in a section view in vertical plane (X, Z), meaning in the plane which passes through central axes A of secondary channels 38.

Friction assembly 1 comprises a brake head 3, and at least one plate 2 made of friction material. Brake head 3 has a lower face 31 and an upper face 32. Plate 2 has a first face 21 which is the friction face, and a second face 22. In operation, plate 2 is secured to brake head 3 by a fixing mechanism (4, 5). For example, this fixing mechanism comprises a receiving slide 5 which is formed on lower face 31, and a dovetail section 4 which is formed on second face 22 and which is configured to engage with receiving slide 5. Thus, plate 2 is secured to brake head 3 by insertion and translational movement of dovetail section 4 in slide 5 along longitudinal axis X. The fixing mechanism is then such that this securing can be undone. Generally speaking, the securing of plate 2 to brake head 3 can be undone, which allows the replacement of plate 2 once it is worn out.

Plate 2 comprises at least one primary channel 28 which connects first face 21 and second face 22 in a fluid-tight manner. In FIG. 1, plate 2 comprises two primary channels 28. Brake head 3 comprises at least one secondary channel 38 of central axis A which connects, in a fluid-tight manner, upper face 32 and lower face 31 at the bottom of receiving slide 5. In FIG. 1, brake head 3 comprises two secondary channels 38. Brake head 3 comprises at least one connecting ring 8 arranged in the at least one secondary channel 38 and establishing a connection with the at least one primary channel 28. In FIG. 1, brake head 3 comprises two connecting rings 8. When plate 2 is secured to brake head 3, each primary channel 28 is aligned with a secondary channel 38, meaning that the central axis of each primary channel 28 is the central axis A of the secondary channel 38 with which it is aligned.

Connecting ring 8 comprises a tubular body 81 and a flange 82 at one end of body 81. Flange 82 extends radially outwards from body 81, and therefore has a diameter greater than the outside diameter of body 81. For example, the inside diameter of body 81 is greater than the diameter of a primary channel 28 so as to compensate for clearances between plate 2 and brake head 3 along axis X. The distal end of body 81 is therefore located opposite from flange 82.

In the description below, the plural is used for the elements “primary channels 28”, “secondary channels 38”, “connecting rings 8”, “holes 58”, as well as the determinant “each”, for the discussion of cases of two or more of these elements. The description below is also valid for the case of a single primary channel 28, a single secondary channel 38, a single connecting ring 8, and a single hole 58.

Friction assembly 1 further comprises a manifold block 50 which is an integral part of brake head 3 at upper face 32. For example, block 50 is a pneumatic manifold block. “Is an integral part” is understood to mean that block 50 cannot be separated from brake head 3, except with tools. For example, block 50 is molded with brake head 3, or is welded to brake head 3. Block 50 covers upper face 32 of brake head 3 at the portion of upper face 32 which comprises the openings of secondary channels 38. Block 50 comprises a cavity 55 which is connected to a circuit 51 which is connected to a suction device. Block 50 has holes 58 which connect cavity 55 and upper face 32, each hole 58 being located in line with one of secondary channels 38. As illustrated in FIG. 1, block 50 therefore comprises two holes 58. As block 50 is an integral part of brake head 3, a ring 8 cannot be inserted into a secondary channel 38 via upper face 32.

Each ring 8 can only be inserted into a secondary channel 38 via lower face 31, before securing plate 2 to brake head 3. Thus, body 81 of a ring 8 is inserted into a secondary channel 38, flange 82 being positioned towards lower face 31. The diameter of flange 82 is equal to or slightly less than the diameter of secondary channel 38. The diameter of each of holes 58 is equal to or slightly greater than the outside diameter of body 81, and is less than the diameter of flange 82. Thus, when ring 8 is inserted into secondary channel 38, flange 82 abuts against the edge of hole 58 which is located facing secondary channel 38, either directly or indirectly, as explained below.

In the case of indirect contact, a spring (for example a helical spring) is mounted on body 81 between flange 82 and the edge of hole 58. At rest, the spring is in contact with flange 82 and the edge of hole 58, and flange 82 protrudes from lower face 31 (for example at the bottom of slide 5 if slide 5 is present). When plate 2 has been secured to brake head 3 (for example by sliding dovetail section 4 of plate 2 in slide 5), second face 22 is in contact with lower face 31, and flange 82 is pushed back into secondary channel 38 and compresses the spring. This solution is shown in FIG. 1.

In the case of direct contact between flange 82 and the edge of hole 58, flange 82 is shaped such that, when not deformed, it protrudes from lower face 31. When plate 2 has been secured to brake head 3, flange 82 is deformed between second face 22 and the edge of hole 58. This deformation is for example a compression of the material of the flange along axis A. Alternatively, flange 82 has a convex or concave shape at rest, and this deformation is a flattening of flange 82. In all cases of direct contact, the deformation of flange 82 also fulfills a sealing function between ring 8 and second face 22.

In both cases of contact (direct or indirect), flange 82 is held against second face 22 of plate 2. This is achieved either by deformation of flange 82 itself, or by compression of the spring, which therefore each constitute a return mechanism 90 which makes it possible to press flange 82 against second face 22. Other return mechanisms 90 fulfilling the same function may be used.

Flange 82 therefore blocks translational movement of ring 8 in secondary channel 38 along axis A in one direction, namely the upwards direction in the figures (upward movement of ring 8).

Friction assembly 1 comprises a securing mechanism 70 for securing connecting rings 8 to block 50 when each of connecting rings 8 is arranged in a hole 58 and in a secondary channel 38. Thus, when a connecting ring 8 is pushed upwards into hole 58 until its distal end is leading into cavity 55, securing mechanism 70 prevents connecting ring 8 from translational movement in the opposite direction, meaning downward. Connecting ring 8 is therefore locked in the position of being secured to block 50 and cannot come out of hole 58.

Various embodiments of this securing mechanism 70 and the method of securing each connecting ring 8 to block 50 will now be described.

In each of the embodiments of this method, the first step (step (a)) consists of providing block 50 with a cavity 55, one or more holes 58 which connect cavity 55 and upper face 32 and which are each located in line with a secondary channel 38 of brake head 30 and in which a ring 8 is able to slide, and a circuit 51 which connects cavity 55 to the suction device.

According to a first embodiment, illustrated in FIGS. 1 to 7, the distal end of body 81 carries tabs 85 which, at rest, extend radially outwards. Tabs 85 are molded, for example. Tabs 85 may be machined and shaped by bending, for example. FIGS. 2 to 5 and 7 are section views in plane (X, Z) of the region of friction assembly 1 which comprises block 50. For clarity, plate 2 is not shown in FIGS. 2 to 5 and 7.

Thus, securing mechanism 70 comprises flange 82, tabs 85, and the internal edge of hole 58 of cavity 55. “Internal edge” designates the edge of a hole 58 which is located inside cavity 55. The operation of the securing mechanism is explained below.

In each hole 58, and in each secondary channel 38 aligned with this hole 58, a connecting ring 8 is inserted by sliding along axis A of hole 58. This insertion is carried out from lower face 31 of the brake head, upwardly in the figures, and constitutes the second step (step (b)).

FIG. 2 illustrates the situation where connecting rings 8 have been inserted into secondary channels 38 and their insertion into holes 58 has begun. The distal ends of tabs 85 are in contact with the external edge of holes 58. “External edge” designates the edge of a hole 58 which is located outside block 50, meaning it is facing secondary channel 38.

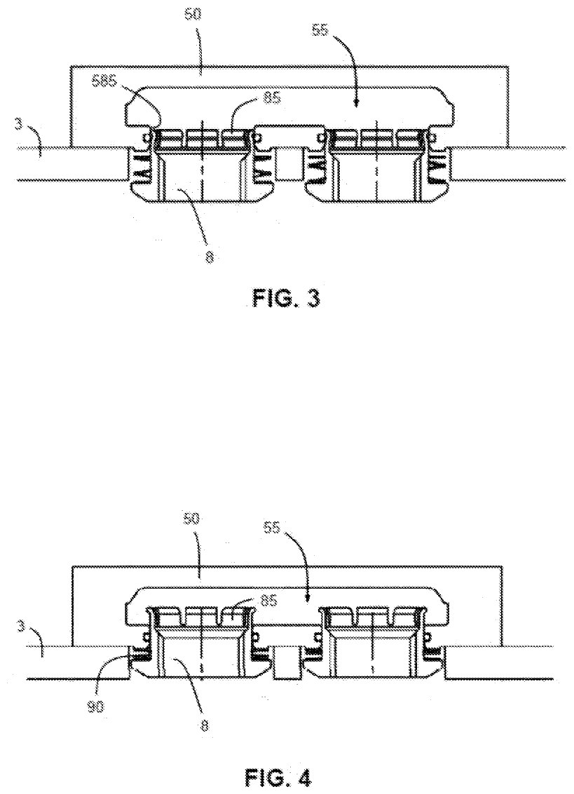

FIG. 3 illustrates the situation where connecting rings 8 have been inserted into holes 58. When hole 58 is entered, the ends of tabs 85 are pushed radially towards the longitudinal central axis of connecting ring 8 by side wall 585 of hole 58. This deformation of tabs 85 is within their elastic range of deformation. Advantageously, the external edge of each hole 58 flares outwardly relative to hole 58 so as to help push tabs 85 radially towards the central axis of the connecting ring. During the translational movement of connecting ring 8 in hole 58, tabs 85 slide along the side wall 585 from the external edge to the internal edge of hole 58.

FIG. 4 illustrates the situation where the distal end of each connecting ring 8 is emerging into cavity 55. Due to their elasticity, tabs 85 then deform radially outwards to return to their initial position (position at rest).

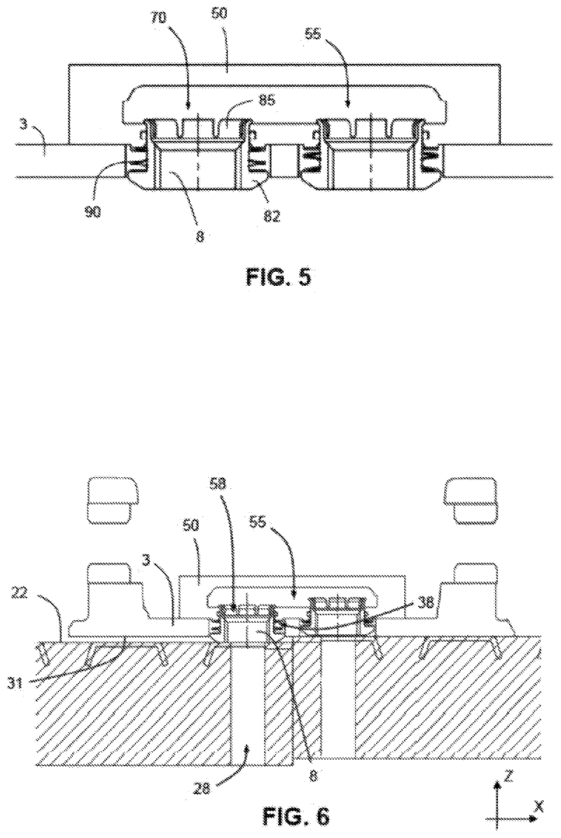

FIG. 5 illustrates the situation where each of connecting rings 8 has been lowered until the distal ends of tabs 85 come into contact with the internal edge of hole 58. Because these distal ends curve radially outward, they press against the internal edge and prevent connecting rings 8 from coming out of holes 58 (step (c), third step). Tabs 85 and the internal edge of hole 58 therefore form part of securing mechanism 70.

Advantageously, friction assembly 1 comprises a return mechanism 90 (in the case illustrated in the figures, this mechanism is a spring around connecting ring 8, located between flange 82 and the external edge of hole 58. For example, this spring is helical). When the distal end of a connecting ring 8 emerges into cavity 55, return mechanism 90 is activated (the spring is compressed) so that it tends to urge connecting ring 8 to come back out of hole 58, meaning connecting ring 8 is pushed downwards, as illustrated in FIG. 5. Flange 82 of each connecting ring 8 then partially emerges at lower face 31 of brake head 3.

During a fourth step (step (d)), plate 2 is assembled onto brake head 3 until plate 2 covers each of connecting rings 8. This situation is illustrated in FIG. 6, in the case where the plate has two halves. FIG. 6 is a section view in plane (X, Z) of a portion of friction assembly 1 illustrated in FIG. 1. In the right part of FIG. 6, the right half of plate 2 is pressed against brake head 3 such that second face 22 of this right half is in contact with lower face 31 of brake head 3. On the left part of FIG. 6, there is some clearance between the left half of plate 2 and the brake head 3 such that second face 22 of this left half is not in contact with lower face 31 of brake head 3. In all cases, return mechanism 90 presses connecting ring 8 against second face 22 of plate 2, and the distal ends of connecting rings 8 are in cavity 55.

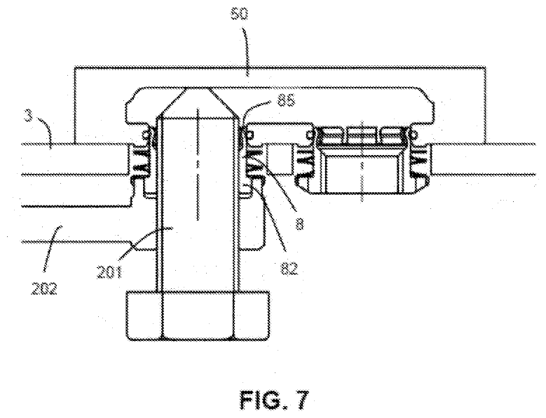

FIG. 7 illustrates a method for separating a connecting ring 8 from block 50. A threaded rod 201 is screwed into the hole of connecting ring 8 along its longitudinal axis such that connecting ring 8 is in a helical connection with rod 201 along its entire length. Then flange 82 of connecting ring 8 is grasped with pliers 202 in order to prevent it from rotating. By screwing rod 201 to abut against the ceiling of cavity 55, connecting ring 8 is moved translationally downwards due to the thread of rod 201. By moving translationally downwards along rod 201, tabs 85 are elastically deformed and forced between rod 201 and side wall 585 of hole 58 until they emerge into secondary channel 38. Connecting ring 8 can then be freely removed from block 50 and brake head 3.

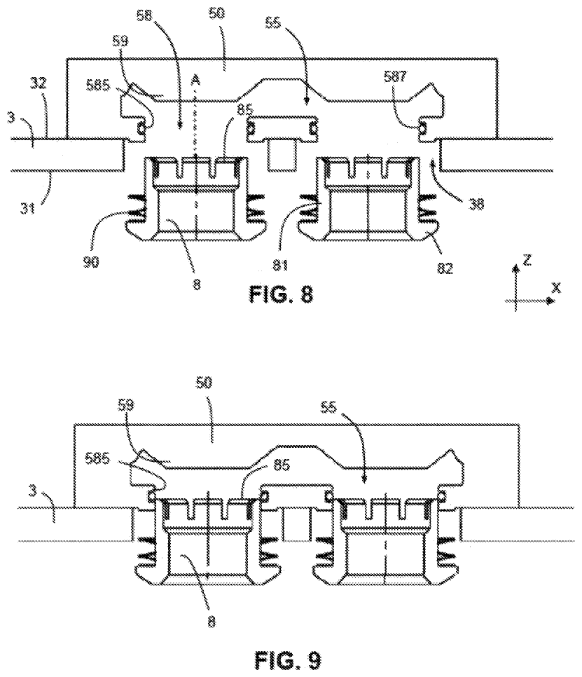

We now describe a second embodiment, illustrated in FIGS. 8 to 12, in which the distal end of body 81 carries tabs 85 which extend substantially as an extension of body 81 in their rest positions and which are able to be plastically deformed radially outwards. FIGS. 8 to 12 are section views, in plane (X, Z), of the region of friction assembly 1 which comprises block 50. For clarity, plate 2 is not shown in these figures.

Thus, securing mechanism 70 comprises flange 82, tabs 85, and the internal edge of hole 58 of cavity 55. The operation of the securing mechanism is explained below.

In each hole 58, and in each secondary channel 38 aligned with hole 58, a connecting ring 8 is inserted by sliding along axis A of hole 58. This insertion is carried out from lower face 31 of the brake head, which is upwardly in the figures, and constitutes the second step (step (b)).

FIG. 8 illustrates the situation where connecting rings 8 have been inserted into secondary channels 38, before their insertion into holes 58 has begun.

FIG. 9 illustrates the situation where connecting rings 8 have been inserted into holes 58. After entering a hole 58, tabs 85 and body 81 slide freely along the side wall 585 of hole 58 from the external edge to the internal edge of hole 58. In fact, tabs 85 extend substantially as an extension of body 81.

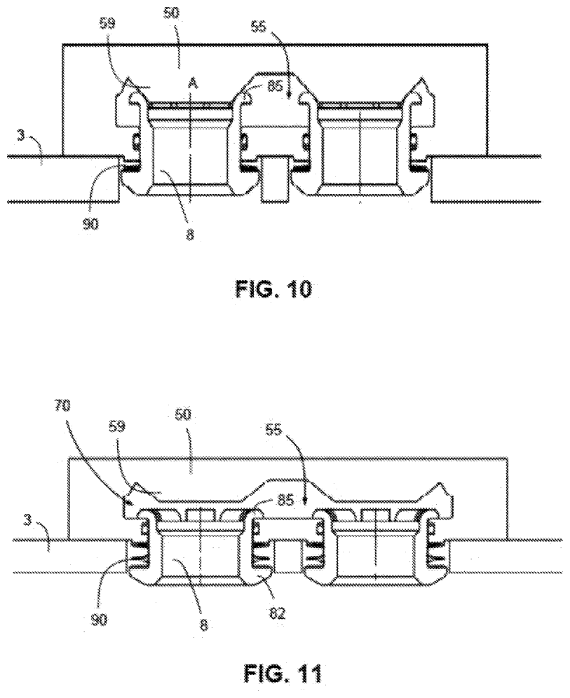

The ceiling of cavity 55 is provided with a conical protuberance 59 in the shape of a cone or truncated cone, facing each hole 58. The axis of symmetry of protuberance 59 is therefore aligned with axis A of hole 58. The base of protuberance 59 is located at this ceiling and its distal end is directed towards hole 58 which is in the floor of cavity 55. After the distal end of each connecting ring 8 emerges into cavity 55, each ring 8 continues to slide upwards until tabs 58 come into contact with the side wall of conical protuberance 59. As each ring 8 continues to slide further upwards, tabs 85 are deformed radially outwards. This deformation takes place within the elastic range of tabs 85 then within their plastic range, such that the deformation of tabs 85 from their initial rectilinear position is permanent. After this plastic deformation, tabs 85 are in a new state at rest in which their distal ends are curved radially outwards. FIG. 10 illustrates this plastic deformation of tabs 85.

FIG. 11 illustrates the situation where each of connecting rings 8 is lowered back down until the distal ends of tabs 85 come into contact with the internal edge of hole 58. These distal ends being curved radially outward, they bear against the internal edge and prevent connecting rings 8 from coming out of holes 58 (step (c), third step). Tabs 85 and the internal edge of hole 58 therefore form part of securing mechanism 70.

Advantageously, friction assembly 1 comprises a return mechanism 90 (in the case illustrated in the figures, this mechanism is a spring around connecting ring 8, located between flange 82 and the external edge of hole 58. For example, this spring is helical). When the distal end of a connecting ring 8 emerges into cavity 55, return mechanism 90 is activated (the spring is compressed) so that it tends to urge connecting ring 8 to come out of hole 58, meaning connecting ring 8 is pushed downwards, as illustrated in FIG. 11. Flange 82 of each connecting ring 8 then partially emerges at lower face 31 of brake head 3.

During a fourth step (step (d)), plate 2 is assembled onto brake head 3 until plate 2 covers each of connecting rings 8. This situation is similar to that illustrated in FIG. 6 in the case of the first embodiment. Return mechanism 90 presses connecting ring 8 against second face 22 of plate 2, and distal ends 85 of connecting rings 8 are in cavity 55.

Advantageously, in the first and second embodiments, side wall 585 of each hole 58 comprises an O-ring 587 which is housed in an annular cavity of side wall 585. O-ring 587 allows improving the seal between connecting ring 8 and block 50.

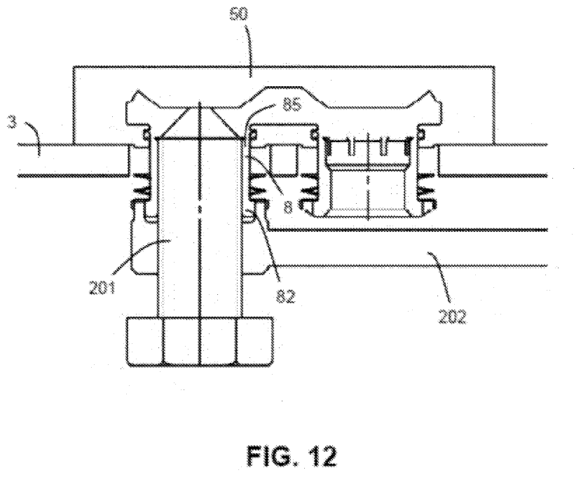

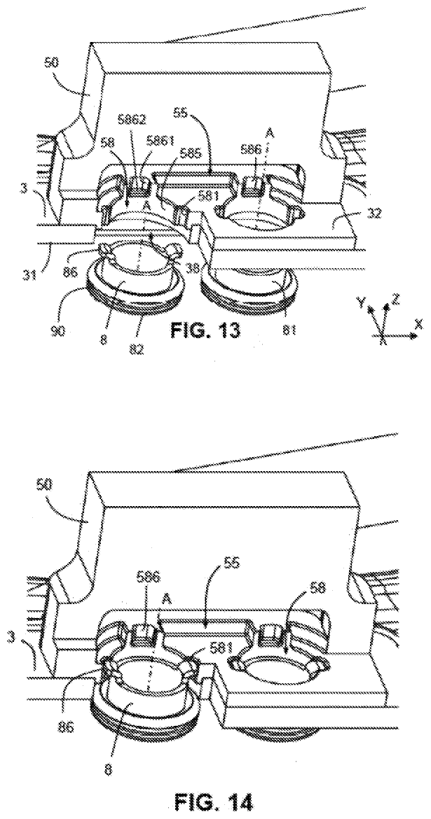

FIG. 12 illustrates a method for separating a connecting ring 8 from block 50. A threaded rod 201 is screwed into the hole of connecting ring 8 along its longitudinal axis such that connecting ring 8 is in a helical connection with rod 201 along its entire length. Then flange 82 of connecting ring 8 is grasped with pliers 202 in order to prevent it from rotating. By screwing rod 201 to abut against the ceiling of cavity 55, connecting ring 8 is moved translationally downwards due to the thread of rod 201. By moving translationally downwards along rod 201, tabs 85 are plastically deformed and forced between rod 201 and side wall 585 of hole 58 until they emerge into secondary channel 38. Connecting ring 8 can then be freely removed from block 50 and brake head 3.

We now describe a third embodiment, illustrated in FIGS. 13 to 16, in which the distal end of body 81 of each connecting ring 8 carries two diametrically opposed protuberances 86 which extend radially outwards. Each hole 58 carries two diametrically opposed grooves 581 which extend longitudinally along its side wall 585 from the internal edge to the external edge of hole 58, such that each of protuberances 86 is able to slide in one of grooves 581 when connecting ring 8 slides in hole 58. The edge of each hole 58 has a housing 586 which is adapted to receive one of protuberances 86. Housing 586 extends radially from the internal edge of hole 58 and is bordered by a side wall 5861 which extends along main axis A. Housing 586 has a bottom 5862 which extends parallel to the floor of cavity 55. Housing 586 is open towards the ceiling of cavity 55 along main axis A, and is open radially towards hole 58. FIGS. 13 to 16 are perspective partial section views, in plane (X, Z), of the region of friction assembly 1 which comprises block 50. For clarity, in each of these figures both connecting rings 8 are shown in their entirety, and for one of connecting rings 8 the cross-section plane is moved translationally along transverse axis Y so as to show the entirety of secondary channel 38 and of hole 58 around this connecting ring 8. Plate 2 is not shown.

In the general case, the distal end of body 81 of each connecting ring 8 can carry a protuberance 86 or more than two protuberances 86. Each hole 58 carries as many grooves 581 as there are protuberances 86, grooves 581 being arranged such that each protuberance 86 slides in one of grooves 581 when connecting ring 8 slides in hole 58.

Thus, securing mechanism 70 comprises flange 82, protuberance(s) 86, and housing 586. The operation of the securing mechanism is explained below.

In each hole 58, and in each secondary channel 38 aligned with this hole 58, a connecting ring 8 is inserted by sliding along axis A of hole 58. This insertion is carried out from lower face 31 of the brake head, upwardly in the figures, and constitutes the second step (step (b)).

FIG. 13 illustrates the situation where connecting rings 8 have been inserted into secondary channels 38, before their insertion into holes 58 has begun.

FIG. 14 illustrates the situation where connecting rings 8 have been inserted into holes 58. As they enter a hole 58, protuberances 86 slide freely in grooves 581 from the external edge to the internal edge of hole 58.

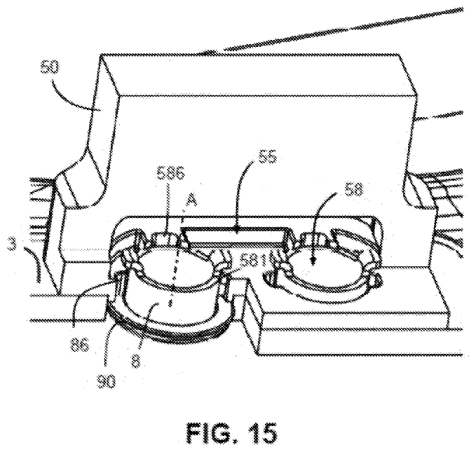

FIG. 15 illustrates the situation where protuberances 86 of each connecting ring 8 are emerging into cavity 55.

Each connecting ring 8 is pressed into hole 58 and pivoted around its main (longitudinal) axis until one of protuberances 86 is located above housing 586. Then each connecting ring 8 is lowered back down until protuberance 86 is housed in housing 586 until it comes into contact with bottom 5862 (step (c), third step).

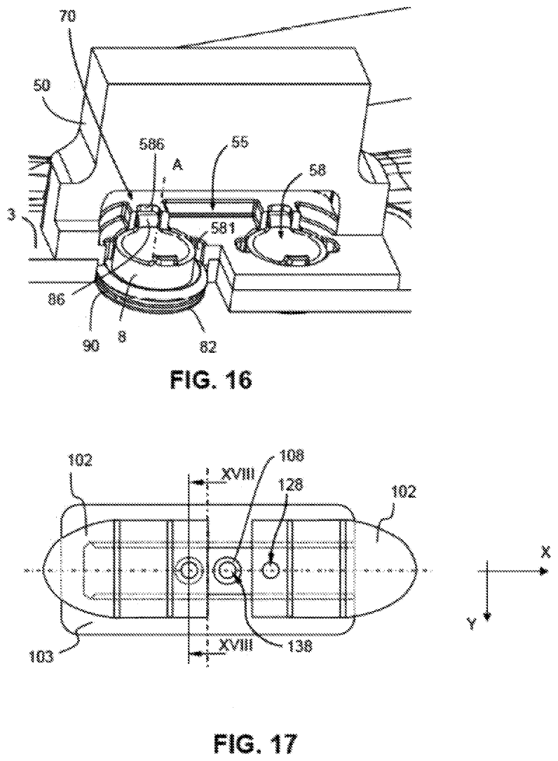

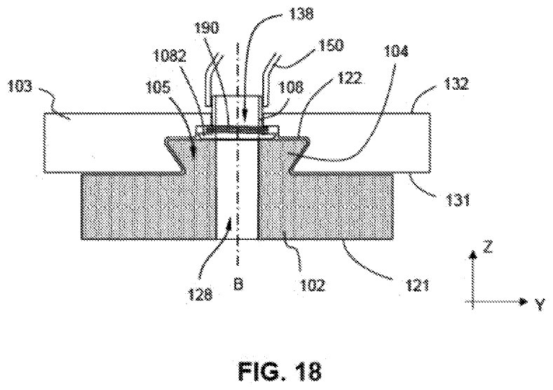

Advantageously, friction assembly 1 comprises a return mechanism 90 (in the case illustrated in the figures this mechanism is a spring around connecting ring 8, located between flange 82 and the external edge of hole 58. For example, this spring is helical). When the distal end of a connecting ring 8 emerges into cavity 55, return mechanism 90 is activated (the spring is compressed) so that it tends to urge connecting ring 8 out of hole 58. Thus, return mechanism 90 pushes connecting ring 8 downwards and maintains protuberance 86 in housing 586 so as to secure connecting ring 8 to block 50, as illustrated in FIG. 16. Flange 82 of each connecting ring 8 then partially emerges at lower face 31 of brake head 3.

During a fourth step (step (d)), plate 2 is assembled onto brake head 3 until plate 2 covers each of connecting rings 8. This situation is similar to that illustrated in FIG. 6 for the case of the first embodiment. Return mechanism 90 presses connecting ring 8 against second face 22 of plate 2, and protuberances 86 of connecting rings 8 are in cavity 55.

To separate a connecting ring 8 from block 50, it is slid upwards to remove protuberance 86 from housing 586. Then connecting ring 8 is pivoted around its main axis until protuberances 86 are aligned with grooves 581. Then connecting ring 8 is pulled downwards so that protuberances 86 slide in grooves 581. Connecting ring 8 is then freely removed from block 50 and brake head 3.

As described above, the method of securing a connecting ring 8 to a block 50 connected to a suction device is as follows:

In the method according to the invention, brake head 3 comprises a lower face 31, an upper face 32, and at least one secondary channel 38 having a central axis A; block 50 is an integral part of brake head 3 at upper face 32; brake head 3 and connecting ring 8 form part of a friction assembly 1 for a railway disc braking system for railway rolling stock which further comprises a plate 2 of friction material comprising a first face 21 which is the friction face, a second face 22 which is adapted to be fixed to lower face 31 by a fixing mechanism 4, 5, and at least one primary channel 28 which connects first face 21 and second face 22; the at least one connecting ring 8 being arranged in the at least one secondary channel 38 and establishing a connection with the at least one primary channel 28 when the at least one primary channel 28 is aligned with one of the at least one secondary channel(s) 38. This method comprises the following steps:
(a) Block 50 is provided with a cavity 55 which is connected by a circuit 51 to the suction device, and with at least one hole 58 which connects cavity 55 and upper face 32 and which is aligned with the at least one secondary channel 38 and in which the at least one connecting ring 8 is adapted to slide;
(b) The at least one connecting ring 8 is arranged in the at least one hole 58 and in the at least one secondary channel 38 by sliding it along axis A from lower face 31;
(c) The at least one connecting ring 8 is secured to block 50 by means of a securing mechanism 70;
(d) Assembly of plate 2 onto brake head 3 is carried out until plate 2 covers the at least one connecting ring 8.

According to a first embodiment, the at least one connecting ring 8 comprises a body 81 and a flange 82 at a first end of body 81, the distal end of body 81 carrying tabs 85 which extend radially outwards in their rest positions, such that, in step (b), tabs 85 approach each other elastically when body 81 slides in the at least one hole 58 and in the at least one secondary channel 38, and, in step (c), tabs 85 return to their rest positions and are able to bear against the internal edge of the at least one hole 58 of cavity 55. Securing mechanism 70 comprises flange 82, tabs 85, and said internal edge of the at least one hole 58.

According to a second embodiment, the at least one connecting ring 8 comprises a body 81 and a flange 82 at a first end of body 81, the distal end of body 81 carrying tabs 85 which extend substantially as an extension of body 81 in their rest positions, such that, in step (b), body 81 slides freely in the at least one hole 58 and in the at least one secondary channel 38, and, in step (c), tabs 85 are crushed against the bottom of the cavity such that the tabs are plastically deformed radially outwards and are able to bear against the edge of the at least one hole 58 of cavity 55. Securing mechanism 70 comprises flange 82, tabs 85, and said internal edge of the at least one hole 58.

According to a third embodiment, the at least one connecting ring 8 comprises a body 81 and a flange 82 at a first end of body 81, the distal end of body 81 carrying at least one protuberance 86 which extends radially outwards, and the at least one hole 58 carrying at least one groove 581 in which the at least one protuberance 86 is adapted to slide, and the internal edge of the at least one hole 58 comprising a housing 586 adapted to receive the at least one protuberance 86 such that, in step (b), body 81 slides freely in the at least one hole 58 and in the at least one secondary channel 38 until the distal end of body 81 emerges into cavity 55, and such that, in step (c), the ring 8 is pivoted about main axis A until one of the at least one protuberance(s) 86 is located in line with housing 586, then ring 8 is slid in the opposite direction until one of protuberance(s) 86 is housed in housing 586 and bears against the bottom of housing 586. Securing mechanism 70 comprises flange 82, the at least one protuberance 86, and housing 586.

1-10. (canceled)

11. Friction assembly for a braking system for railway rolling stock, said friction assembly comprising:
a brake head comprising a lower face, an upper face, and at least one secondary channel having a central axis A, the at least one secondary channel connecting connects said lower face and an upper face;
at least one plate made of a friction material and comprising a first face which is the friction face, a second face which is adapted to be fixed on said lower face by a fixing mechanism, and at least one primary channel, wherein the at least one primary channel connects said first face to said second face;
at least one connecting ring, a respective ring of the at least one connecting ring being arranged in a respective secondary channel of said at least one secondary channel;
a manifold block connected to a suction device and being integral with the manifold block at said upper face, said manifold block having a cavity which is connected to the suction device and which comprises at least one hole, the at least one hole connecting said cavity to said upper face, and a respective hole of the at least one hole being aligned with a respective secondary channel of the at least one secondary channel, wherein a respective connecting ring of the at least one ring is configured to slide in a respective hole of the at least one hole; and
a securing mechanism for securing said at least one connecting ring to said manifold block when said at least one connecting ring is arranged in said at least one hole and in said at least one secondary channel.

12. The friction assembly according to claim 11, wherein said at least one connecting ring comprises:
a body having a first end and a second end opposite the first end;
a flange arranged at the first end of said body; and
tabs arranged at the second end of said body; the tabs extending radially outwards in said cavity,
wherein said securing mechanism comprises said flange, said tabs, and an internal edge of said at least one hole of said cavity.

13. The friction assembly according to claim 11, wherein said at least one connecting ring comprises:
a body having a first end and a second end opposite the first end;
a flange arranged at the first end of said body; and
tabs arranged at the second end of said body, the tabs being plastically deformed radially outwards in said cavity,
wherein said securing mechanism comprises said flange, said tabs, and an internal edge of said at least one hole of said cavity.

14. The friction assembly according to claim 11, wherein said at least one connecting ring comprises:
a body having a first end and a second end opposite the first end;
a flange arranged at the first end of said body; and
at least one protuberance arranged at the second end of said body, the at least one protuberance extending radially outwards in said cavity, wherein said at least one hole carries at least one groove within which said at least one protuberance is adapted to slide, wherein an internal edge of said at least one hole of the cavity comprises a housing adapted to receive said protuberance, and wherein said securing mechanism comprises said flange, said protuberance, and said housing.

15. The friction assembly according to claim 11, further comprising a return mechanism which is adapted to press said connecting ring against said second face.

16. The friction assembly according to claim 11, wherein said fixing mechanism comprises a receiving slide which is formed on said lower face, and a dovetail section which is formed on said second face and which is configured to engage with said receiving slide.

17. Method for securing at least one connecting ring mounted on a brake head to a manifold block connected to a suction device, said brake head comprising a lower face, an upper face, and at least one secondary channel having a central axis A, said block forming an integral part of said brake head at said upper face, the brake head and said connecting ring forming part of a friction assembly for a braking system for railway rolling stock, said friction assembly further comprising a plate made of friction material comprising a first face which is the friction face, a second face which is adapted to be fixed to said lower face by a fixing mechanism, and at least one primary channel, the at least one primary channel connecting said first face and said second face, said at least one connecting ring being arranged in said at least one secondary channel, said method comprising the following steps:
providing said manifold block with a cavity which is connected to the suction device, and with at least one hole which connects said cavity to said upper face and which is aligned with said at least one secondary channel and in which said at least one connecting ring is adapted to slide;
positioning said at least one connecting ring in said at least one hole and in said at least one secondary channel by sliding the at least one connecting ring along the central axis A from said lower face;
securing said at least one connecting ring to said manifold block by means of a securing mechanism;
assembling said plate onto said brake head until said plate covers said at least one connecting ring.

18. Method according to claim 17, wherein said at least one connecting ring comprises:
a body having a first end and a second end opposite the first end;
a flange arranged at the first end of said body; and
tabs arranged at the second end of said body; the tabs extending radially outwards in their rest positions,
wherein, in the step “positioning said at least one connecting ring”, said tabs approach each other elastically when said body slides in said at least one hole and in said at least one secondary channel, and
wherein in step “securing said at least one connecting ring”, said tabs return to their rest positions and are able to bear against an internal edge of said at least one hole of said cavity, said securing mechanism comprising said flange, said tabs, and said internal edge of the at least one hole.

19. The method according to claim 17, wherein the at least one connecting ring comprises:
a body having a first end and a second end opposite the first end;
a flange arranged at the first end of said body; and
tabs arranged at the second end of said body; the tabs extending substantially as an extension of said body in their rest positions,
wherein, in the step “positioning said at least one connecting ring”, said body slides freely in said at least one hole and in said at least one secondary channel, and
wherein in step “securing said at least one connecting ring”, said tabs are crushed against a bottom of said cavity such that said tabs are plastically deformed radially outwards and are able to bear against an internal edge of said at least one hole of said cavity, said securing mechanism comprising said flange, said tabs, and said internal edge of the at least one hole.

20. The method according to claim 17, wherein the at least one connecting ring comprises:
a body having a first end and a second end opposite the first end;
a flange arranged at the first end of said body; and
at least one protuberance which extends radially outwards, wherein said at least one hole carries at least one groove in which said at least one protuberance is adapted to slide, and wherein an internal edge of said at least one hole comprises a housing adapted to receive said at least one protuberance,
wherein in the step “positioning said at least one connecting ring”, said body slides freely in said at least one hole and in said at least one secondary channel until the second end of said body emerges into said cavity, and
wherein in step “securing said at least one connecting ring”, said connecting ring is pivoted about the central axis A until one of said at least one protuberance is located facing said housing, then said ring is slid in the opposite direction until one of said protuberance is housed in said housing and bears against a bottom of the housing, said securing mechanism comprising said flange, said at least one protuberance, and said housing.
